(19) United States
(12) Patent Application Publication
(10) Pub. No.: US 2026/0167076 A1
(43) Pub. Date: Jun. 18, 2026

(54) VEHICULAR INTERIOR COMPONENT

(71) Applicant: TOYOTA BOSHOKU KABUSHIKI KAISHA, Aichi-ken (JP)

(72) Inventors: Atsushi IINUMA, Owariasahi-shi (JP); Kenji OKAMOTO, Nagoya-shi (JP); Yuki MIZUNO, Aichi-gun (JP); Yoshifumi MATSUSHITA, Toyota-shi (JP); Yuichi KOBAYASHI, Ikeda-shi (JP)

(73) Assignee: TOYOTA BOSHOKU KABUSHIKI KAISHA, Aichi-ken (JP)

(21) Appl. No.: 19/411,728

(22) Filed: Dec. 8, 2025

(30) Foreign Application Priority Data
Dec. 12, 2024 (JP) 2024-217440

(51) Int. Cl. B60N 2/75; B60R 13/02

(52) U.S. Cl. CPC B60N 2/78; B60R 13/0206; B60R 13/0243

(57) ABSTRACT

A vehicular interior component includes a projection portion projecting toward a vehicular interior side and including a wall portion facing the vehicular interior side, an upper surface member, and a side surface member. The upper surface member includes a body and a fitting portion extending from the body and having a through hole. The fitting portion includes a first extending portion that extends from the body toward the vehicular interior side, and a second extending portion that is contacted with the wall portion from the vehicular interior side. The side surface member includes a side member body covering the wall portion from the vehicular interior side, and a first stopper piece extending from a vehicular exterior side surface of the upper portion to the through hole and is inserted in the through hole and is contacted with an inner surface of the through hole from the vehicular exterior side.

### CROSS REFERENCE TO RELATED APPLICATION

This application claims priority from Japanese Patent Application No. 2024-217440 filed on Dec. 12, 2024. The entire contents of the priority application are incorporated herein by reference.

### TECHNICAL FIELD

The present technology described herein relates to a vehicular interior component.

### BACKGROUND

There has been known a door trim as a vehicular interior component. One example of a door trim includes an armrest that projects toward a vehicular interior side. The armrest includes a projection portion (an armrest body) that projects from an interior component body (a door trim body), an upper surface member (a switch bezel) configured as a portion of an upper surface of the armrest, and a side surface member (a garnish) configured as a portion of a vehicular interior side surface.

### SUMMARY

In the configuration of the armrest including multiple members as described above, when the members of the armrest are moved by the load applied to the armrest by a passenger, a gap may be created between the members of the armrest and this deteriorates a design. Therefore, to improve the design, there has been a demand to suppress moving of the members of the armrest.

An object of the present technology described herein is to provide a vehicular interior component in which members of an armrest are less likely to move.

According to the technology described herein, a vehicular interior component in which members of an armrest are less likely to move is provided.

### BRIEF DESCRIPTION OF THE DRAWINGS

FIG. 1 is a perspective view of a door trim of a vehicle according to one embodiment.

FIG. 2 is an enlarged perspective view illustrating a projection portion of the trim board.

FIG. 3 is a perspective view illustrating the projection portion to which a switch base is attached.

FIG. 4 is a perspective view of the switch base seen from a vehicular interior side.

FIG. 5 is a perspective view of the switch base seen from a vehicular exterior side.

FIG. 6 is a perspective view of a decoration member seen from the vehicular exterior side.

FIG. 7 is a cross-sectional view illustrating a first stopper piece 81 and taken along line VII-VII in FIG. 10.

FIG. 8 is a cross-sectional view illustrating a second stopper piece 46 and taken along line VIII-VIII in FIG. 10.

FIG. 9 is a cross-sectional view illustrating a fitting projection 73A and taken along line IX-IX in FIG. 10.

FIG. 10 is a perspective view illustrating a front portion of a wall portion 25 seen from the vehicular exterior side.

### DETAILED DESCRIPTION

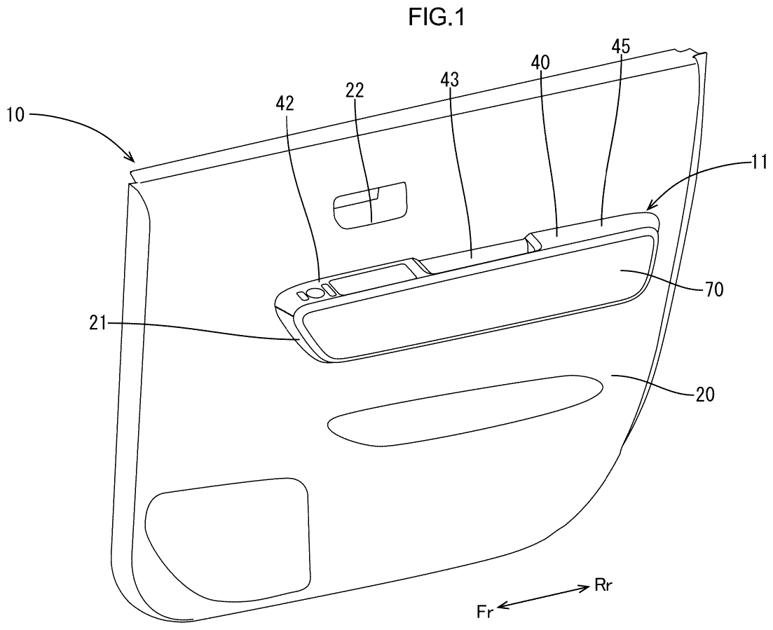

A door trim 10 (a vehicular door trim) according to one embodiment will be described with reference to FIGS. 1 to 10. The door trim 10 of this embodiment is disposed on a side of a vehicle occupant as a vehicular interior component. The door trim 10 is mounted on a vehicular interior side of a door inner panel of a vehicular door. The door trim 10 has a surface that is configured as a vehicular interior side surface of the vehicular door. As illustrated in FIG. 1, the door trim 10 includes a trim board 20 (an interior component body) that covers the door inner panel from a vehicular interior side, a switch base 40 (an upper surface member) that is configured as a portion of an upper surface of the armrest 11, and a decoration member 70 (a side surface member) that is configured as a vehicular interior side surface of the armrest 11. In the drawings, arrows of Fr and Rr represent a front side and a rear side of a vehicle and arrows of IN and OUT represent a vehicular interior side and a vehicular exterior side with respect to a vehicular width direction.

The trim board 20 has a plate shape and is made of synthetic resin such as polypropylene. The material of the trim board 20 may be a mixture of synthetic resin and wood base material (such as kenaf, hemp, flax, sisal).

As illustrated in FIG. 1, the trim board 20 includes a projection portion 21 that projects toward the vehicular interior side. The projection portion 21, the switch base 40, and the decoration member 70 are configured as the armrest 11. The trim board 20 includes a handle mount hole 22 above the armrest 11. An inside handle is fitted in the handle mount hole 22.

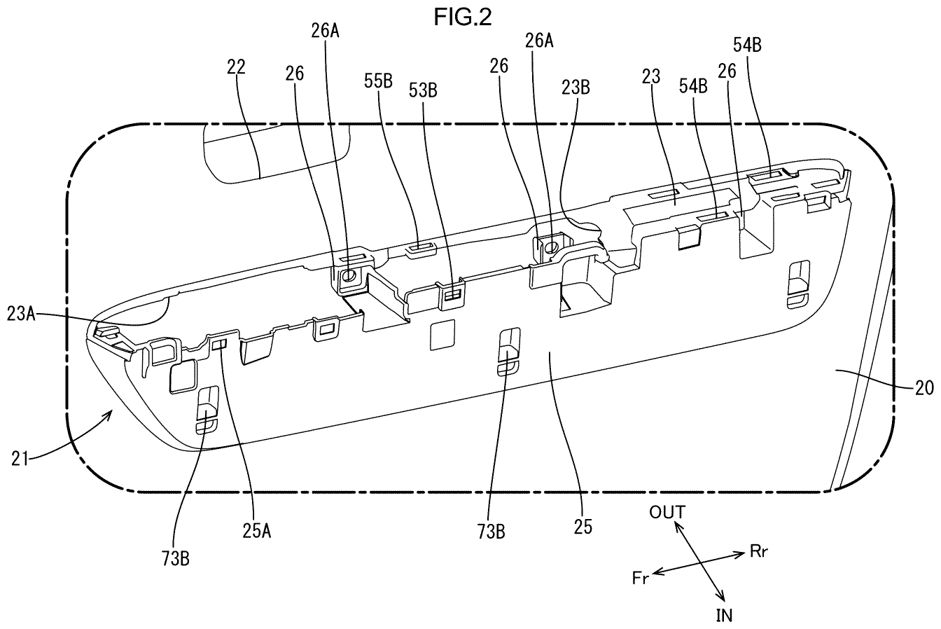

As illustrated in FIG. 2, the projection portion 21 includes a wall portion 25 (a first wall portion) that is a side wall facing an interior space of a vehicle and an upper wall portion 23 that is an upper wall facing upward. The wall portion 25 includes fixing portions 26 that are arranged along a vehicular front-rear direction. The fixing portions 26 project from the wall portion 25 toward the vehicular exterior side. The fixing portions 26 include mounting holes 26A at vehicular exterior side end portions (projecting end portions), respectively. Fixing members are inserted through the mounting holes 26A, respectively. The fixing members inserted through the mounting holes 26A are fixed to the door inner panel.

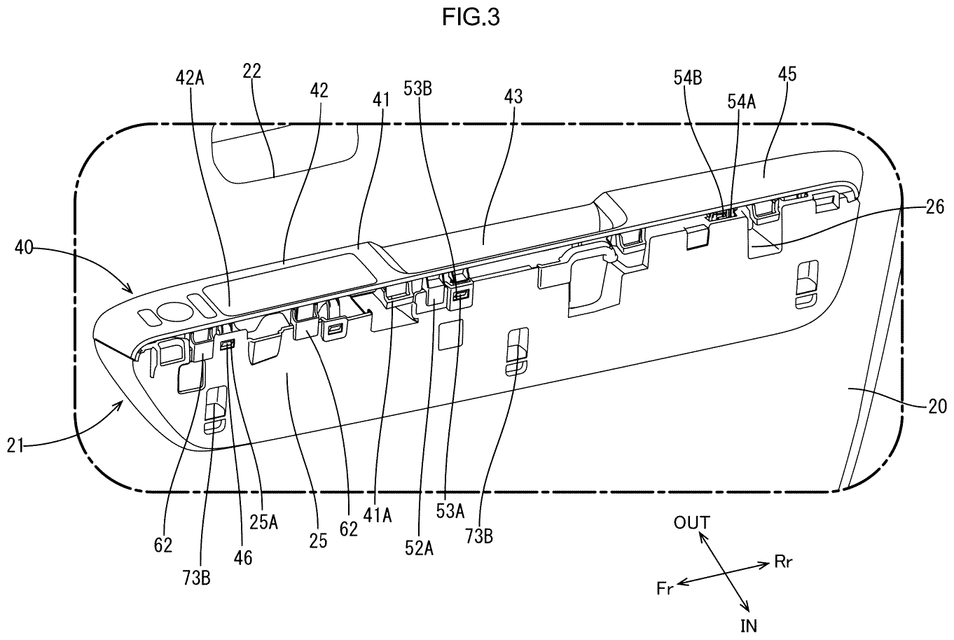

As illustrated in FIG. 3, a middle one of the three fixing portions 26 is covered by a pull handle box 43 from the vehicular interior side. Therefore, to separate the door trim 10 from the door inner panel for maintenance, the decoration member 70 and the switch base 40 need to be detached from the projecting portion 21 to expose the three fixing portions 26 to the vehicular interior space.

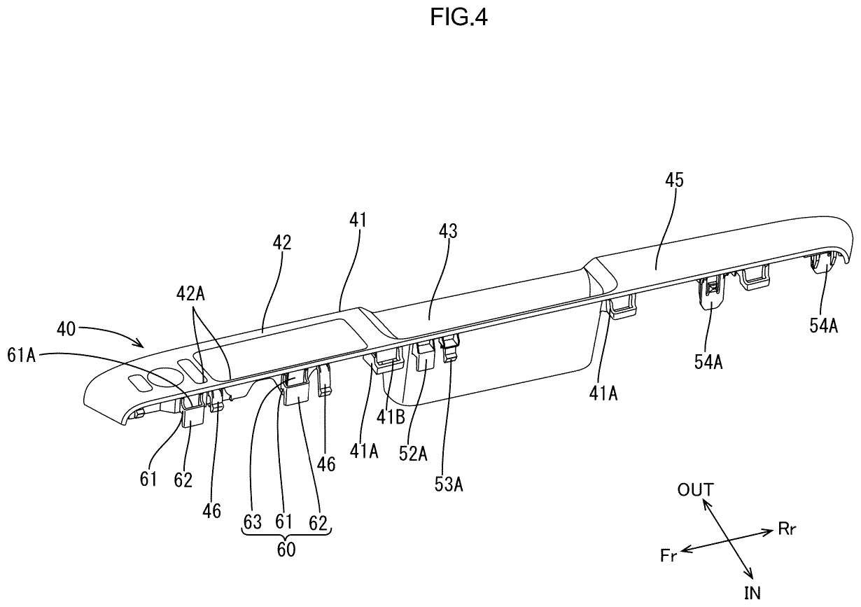

As illustrated in FIG. 4, the switch base 40 is attached to the projection portion 21 from an upper side. In this embodiment, after the switch base 40 is attached to the projection portion 21, the decoration member 70 is attached. The switch base 40 is made of material having rigidity higher than the material of the trim board 20. With the trim board 20 being made of polypropylene, the switch base 40 is made of ABS resin, for instance. As illustrated in FIG. 4, the switch base 40 includes a front section 42, a placement portion 45 in a rear section, and the pull handle box 43 between the front section 42 and the placement portion 45.

As illustrated in FIG. 4, the switch base 40 includes a switch base body 41 (an upper surface member body) that covers the projection portion 21 from above. The switch base body 41 extends in a vehicular front-rear direction. The switch base body 41 includes switch mount holes 42A in the front section 42 for receiving switches. The pull handle box 43 opening upward is in a middle section of the switch base body 41 with respect to the vehicular front-rear direction. The placement portion 45 is in a vehicular rear section of the switch base body 41 and an occupant of the vehicle puts his or her elbow on the placement portion 45.

As illustrated in FIG. 2, the upper wall portion 23 of the projection portion 21 includes a front through hole 23A in a vehicular front section. The front section 42 of the switch base body 41 is inserted in the front through hole 23A from above. The upper wall portion 23 includes a middle through hole 23B in a middle section with respect to the vehicular front-rear direction. The pull handle box 43 is inserted in the middle through hole 23B from above.

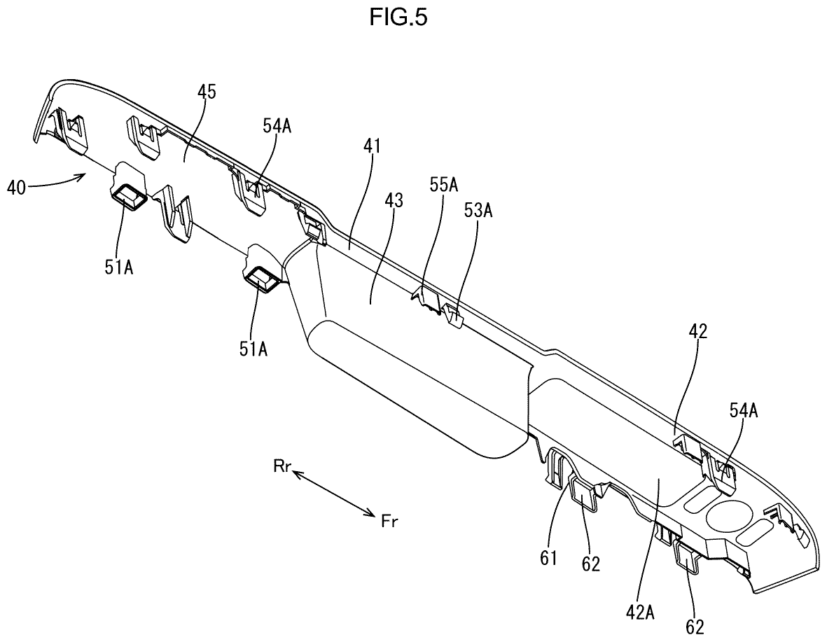

As illustrated in FIGS. 4 and 5, fitting projections 53A, 54A and stopper pieces 52A, 55A are on a lower surface of a peripheral edge portion of the switch base body 41. As illustrated in FIG. 4, the stopper piece 52A and the fitting projections 53A, 54A are on the vehicular interior side portion of the peripheral edge portion of the switch base body 41. As illustrated in FIG. 5, the fitting projections 53A, 54A and the stopper piece 55A are on the vehicular exterior side portion of the peripheral edge portion of the switch base body 41. The fitting projection 54A projects downward from the switch base body 41 and is a flat-shaped projection. The fitting projection 54A includes a U-shaped through hole in a middle portion. With such a configuration, the fitting projection 54A is configured such that only the middle portion is warped.

As illustrated in FIG. 3, the stopper piece 52A that is disposed on the vehicular interior side portion of the peripheral edge portion of the switch base body 41 are hooked on the upper edge portion of the wall portion 25 of the projection portion 21 and disposed on the vehicular interior side of the wall portion 25. The distal end portion of the fitting projection 53A that is disposed on the vehicular interior side portion of the peripheral edge portion of the switch base body 41 is inserted in a fitting hole 53B that is in an upper end portion of the wall portion 25.

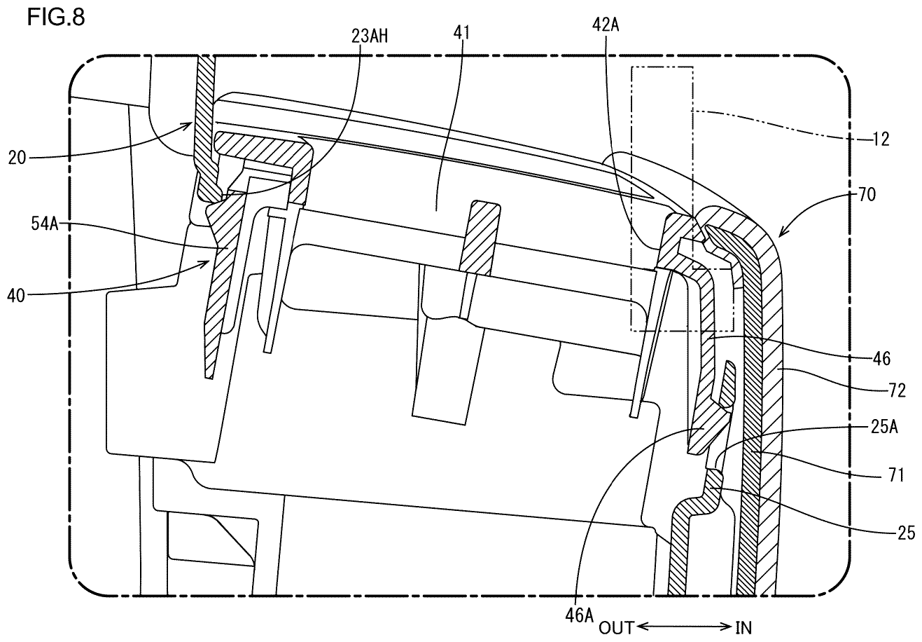

The stopper piece 55A that is disposed on the vehicular exterior side portion of the peripheral edge portion of the switch base body 41 is inserted in a fitting hole 55B (refer to FIG. 2) from above. The fitting hole 55B is in the vehicular exterior side portion of the peripheral edge portion of the upper wall portion 23. The fitting projection 53A that is disposed on the vehicular exterior side portion of the peripheral edge portion of the switch base body 41 (refer to FIG. 5) is stopped by a hole edge portion of the middle through hole 23B of the upper wall portion 23 from a lower side. The fitting projections 54A are inserted in fitting holes 54B (refer to FIG. 2), which are in the peripheral edge portion of the upper wall portion 23, from above. As illustrated in FIG. 8, one of the fitting projections 54A on the vehicular exterior side portion is contacted with the hole edge 23AH of the front through hole 23A from a lower side and fixed.

With the fitting projections 53A, 54A being fitted and connected to the projection portion 21, the switch base 40 is less likely to move upward and in the vehicular interior-exterior direction. With the stopper pieces 52A, 55A being fitted to the projection portion 21, the switch base 40 is less likely to move in the vehicular front-rear direction and the vehicular interior-exterior direction.

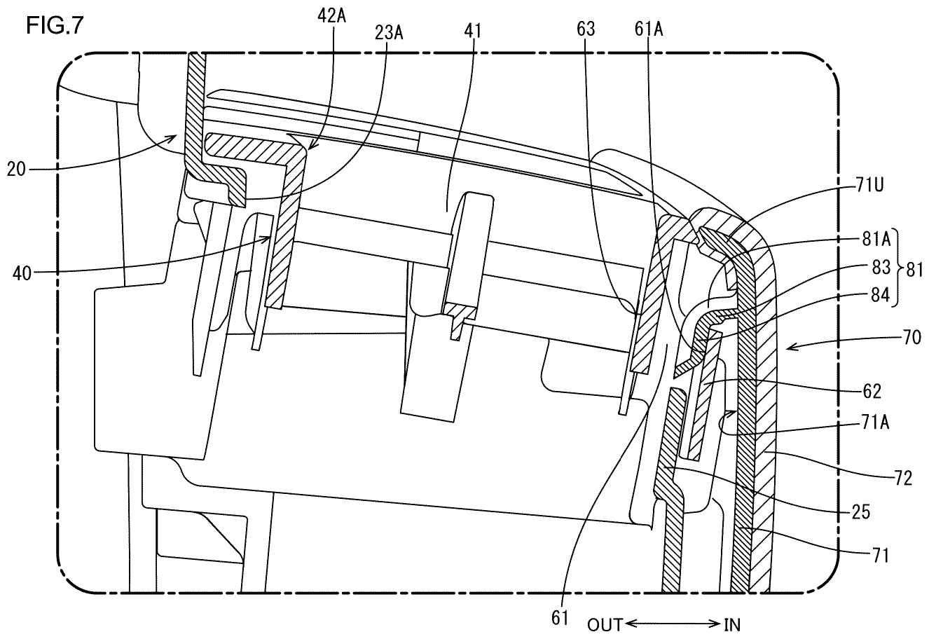

The decoration member 70 is attached to the wall portion 25 of the projection portion 21 from the vehicular interior side. As illustrated in FIG. 7, the decoration member 70 includes a decoration member body 71 (a side surface member body) that covers the wall portion 25 from the vehicular interior side and a skin member 72 that covers the decoration member body 71 from the vehicular interior side.

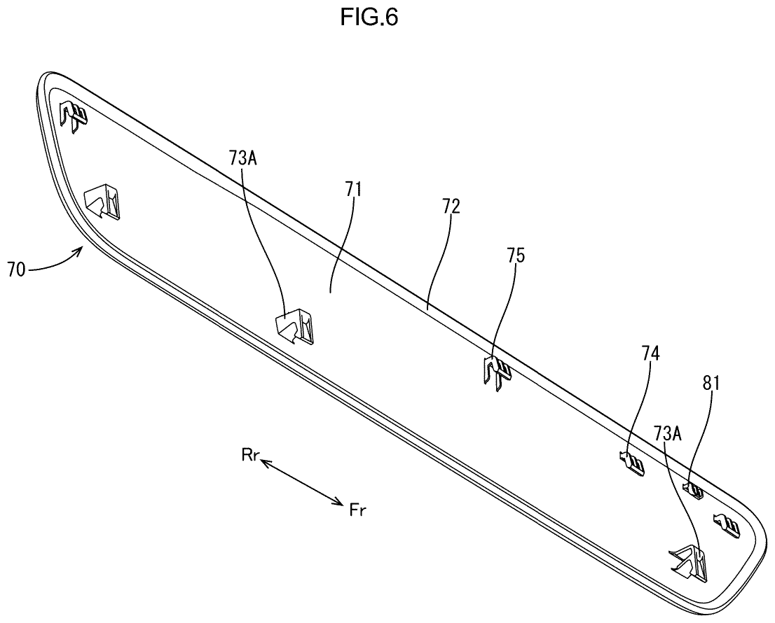

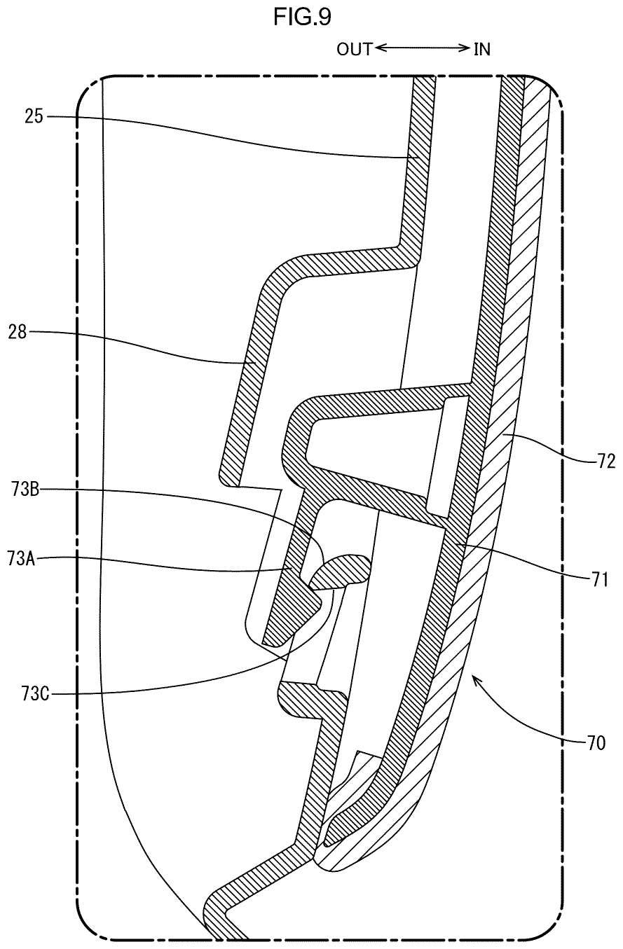

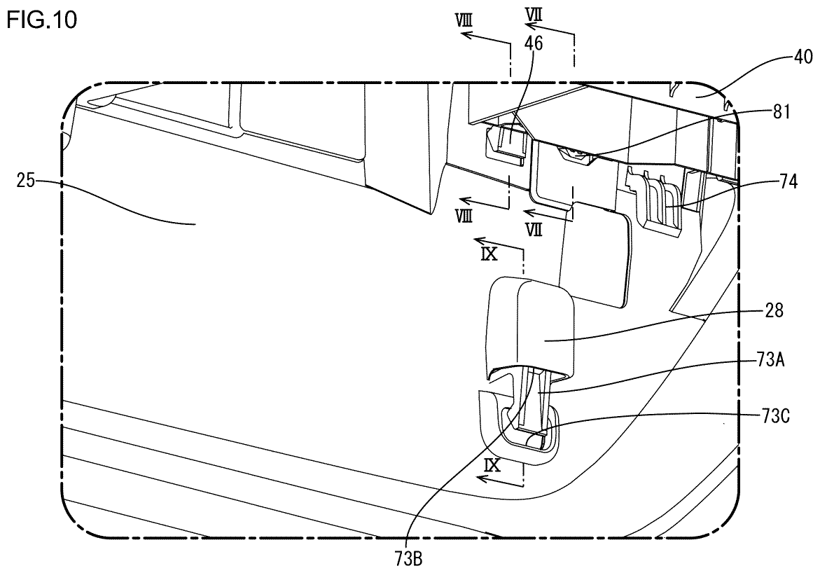

As illustrated in FIG. 6, the decoration member body 71 includes fitting projections 73A on a lower portion of a vehicular exterior side surface 71A. The fitting projections 73A are arranged in the vehicular front-rear direction. As illustrated in FIGS. 9 and 10, the wall portion 25 includes a recessed portion 28 that is recessed toward the vehicular exterior side and opens downward. A through hole 73B is below the recessed portion 28 and through in the upper-bottom direction. A through hole 73C is in a portion of the wall portion 25 below the through hole 73B. The fitting projection 73A is inserted in the recessed portion 28 from the vehicular interior side and through the through hole 73B from above and then, the distal end portion of the fitting projection 73A is inserted in the through hole 73C.

As illustrated in FIG. 6, the decoration member body 71 includes stopper pieces 74, 75 on the vehicular exterior side surface 71A of the decoration member body 71. The stopper pieces 74, 75 project from the vehicular exterior side surface 71A of the decoration member body 71. The stopper pieces 74, 75 are arranged in the vehicular front-rear direction. As illustrated in FIG. 10, the stopper piece 74 is stopped by an upper edge portion of the wall portion 25. The stopper piece 74 is disposed on the vehicular exterior side with respect to the wall portion 25. The stopper piece 74 is in a front section of the decoration member body 71 that is a right lower portion of the decoration member body 71 in FIG. 6. As illustrated in FIG. 4, a fitting piece 41A projects downward from the vehicular interior side portion of the peripheral portion of the switch base body 41 and the fitting piece 41A has a fitting hole 41B. The stopper piece 75 is inserted in the fitting hole 41B of the fitting piece 41A from above.

As illustrated in FIG. 8, an upper edge portion of the skin member 72 is folded back to the vehicular exterior side of the decoration member body 71. To attach the skin member 72 to the decoration member body 71, a folded portion of the skin member 72 is pressed from the vehicular exterior side with a jig 12 (illustrated with an imaginary line in FIG. 8). As illustrated in FIG. 6, the stopper piece 74 of the vehicular front section is away from the upper edge of the decoration member body 71 not to be contacted with the jig 12.

Next, a fitting structure of the front section 42 of the switch base 40 and a front section of the decoration member 70 will be described. As illustrated in FIG. 4, the switch base 40 includes a fitting portion 60 that extends from the switch base body 41. As illustrated in FIGS. 4 and 7, the fitting portion 60 includes an extending portion 63, first extending portions 61, and a second extending portion 62. The extending portion 63 is a plate member having surfaces facing the vehicular exterior side and the vehicular interior side. The extending portion 63 extends downward from the vehicular interior edge portion of the switch base body 41. The first extending portion 61 extends from a vehicular interior side edge portion of the switch base body 41 toward the vehicular interior side. The first extending portions 61 are plate members that extend from a front edge and a rear edge of the extending portion 63 toward the vehicular interior side. The first extending portions 61 are opposite each other with respect to the front-rear direction. The second extending portion 62 extends downward from a vehicular interior end of the first extending portion 61. The second extending portion 62 is a plate member that extends downward from the vehicular interior ends of the first extending portions 61. The second extending portion 62 extends between the front and rear first extending portions 61 to connect them. As illustrated in FIG. 7, the second extending portion 61 faces the extending portion 63. The second extending portion 62 is stopped by the upper edge portion of the wall portion 25 and is disposed on the vehicular interior side of the wall portion 25. As illustrated in FIGS. 4 and 7, the fitting portion 60 includes a through hole 61A that is through in the upper-bottom direction. The fitting portion 60 has a tubular shape. The through hole 61A is defined by the first extending portions 61 that face each other and the extending portion 63 and the second extending portion 62 that face each other. The fitting portion 60 is fitted to the upper edge of the wall portion 25. As illustrated in FIG. 7, the upper edge portion of the wall portion 25 is fitted in the through hole 61A from the lower side.

As illustrated in FIG. 6, the decoration member 70 includes a first stopper piece 81 that projects from the vehicular exterior side surface 71A of the decoration member body 71. As illustrated in FIG. 7, the first stopper piece 81 has an L shape and extends from an upper edge portion 71U of the decoration member body 71 toward the vehicular exterior side and downward. The upper edge portion 71U is upper than the first extending portions 61. The first stopper piece 81 extends from the vehicular exterior side surface 71A of the upper edge portion 71U of the decoration member body 71. The first stopper piece 81 extends to the through hole 61A. The decoration member body 71 includes the upper edge portion 71U that is on the vehicular interior side of the first extending portions 61 and upper than the first extending portions 61. The first stopper piece 81 is inserted in the through hole 61A from above and thus, the first stopper piece 81 is stopped by the inner surface of the through hole 61A. Specifically, the first stopper piece 81 is contacted with the inner surface of the through hole 61A from the vehicular exterior side. The first stopper piece 81 is contacted with the second extending portion 62 from the vehicular exterior side.

Specifically, as illustrated in FIG. 7, the first stopper piece 81 includes an exterior extending portion 83 (a third extending portion), a downward extending portion 84 (a fourth extending portion), and ribs 81A. The exterior extending portion 83 extends from the vehicular exterior side surface 71A of the decoration member body 71 toward the vehicular exterior side. The downward extending portion 84 extends downward from a vehicular exterior side end portion of the exterior extending portion 83. The downward extending portion 84 is inserted in the through hole 61A from above and is stopped by the second extending portion 62. The downward extending portion 84 is contacted with the second extending portion 62 from the vehicular exterior side. The downward extending portion 84 is contacted with an inner surface of the through hole 61A. The exterior extending portion 83 covers a portion of a hole edge of the through hole 61A of the fitting portion 60 from above. The ribs 81A project from vehicular exterior side surfaces of the exterior extending portion 83 and the downward extending portion 84.

As illustrated in FIG. 4, the switch base body 41 includes second stopper pieces 46 on the vehicular interior side edge portion thereof. The second stopper piece 46 is adjacent to the second extending portion 62. As illustrated in FIG. 8, the second stopper piece 46 is fitted to the wall portion 25 from the vehicular exterior side. The second stopper piece 46 includes a fitting projection 46A at the distal end thereof. The fitting projection 46A is fitted in a fitting hole 25A, which is in an upper edge portion of the wall portion 25, from the vehicular exterior side. Accordingly, the fitting projection 46A of the second stopper piece 46 is stopped by a hole edge of the fitting hole 25A and contacted with the hole edge of the fitting hole 25A from a lower side. The fitting projection 46A is contacted with an inner surface of the fitting hole 25A from a lower side.

Next, effects of this embodiment will be described. The decoration member 70 includes the first stopper piece 81 that is contacted with the inner surface of the through hole 61A in the first extending portion 61 from the vehicular exterior side. Accordingly, the decoration member 70 is less likely to move toward the vehicular interior side with respect to the switch base 40 and a gap is less likely to be created between the decoration member 70 (particularly the upper edge portion 71U of the decoration member body 71) and the switch base 40. The second extending portion 62 that extends downward from the first extending portion 61 is stopped by the wall portion 25 of the projection portion 21. The second extending portion 62 is contacted with the wall portion 25 from the vehicular interior side. With such a configuration, the switch base 40 is less likely to move toward the vehicular exterior side with respect to the projection portion 21. With the second extending portion 62 being contacted with the wall portion 25 from the vehicular interior side, the switch base 40 is less likely to move to be rotated such that the upper portion of the switch base 40 moves toward the vehicular interior side (in a clockwise direction in FIG. 7). If the switch base 40 is rotated and the opening direction of the through hole 61A changes, the fitting of the first stopper piece 81 and the inner surface of the through hole 61A may be released. However, in this embodiment, the switch base 40 is less likely to be rotated and the first stopper piece 81 is less likely to move out from the through hole 61A.

The switch base 40 includes the second stopper piece 46 that is fitted to the wall portion 25 from the vehicular exterior side. The switch base 40 includes the second extending portion 62 that is contacted with the wall portion 25 from the vehicular interior side and the second stopper piece 46 that is fitted to the wall portion 25 from the vehicular exterior side. With such a structure, the switch base 40 is further less likely to move in the vehicular interior-exterior direction.

The first stopper piece 81 includes the exterior extending portion 83 and the downward extending portion 84. The exterior extending portion 83 extends from the vehicular exterior side surface 71A of the decoration member body 71 toward the vehicular exterior side. The downward extending portion 84 extends downward from the vehicular exterior side end portion of the exterior extending portion 83 and is inserted in the through hole 61A from above. Thus, the downward extending portion 84 is contacted with the inner surface of the through hole 61A from the vehicular exterior side. The exterior extending portion 83 covers a portion of the hole edge of the through hole 61A of the fitting portion 60 from above.

Even if the first extending portion 61 of the switch base 40 moves upward, the first extending portion 61 is contacted with the exterior extending portion 83 and does not move further upward. Accordingly, the switch base 40 is less likely to move upward.

### OTHER EMBODIMENTS

The technology described herein is not limited to the embodiments described above with reference to the drawings. The following embodiments may be included in the technical scope. The technology described herein may be modified within the technical scope.
(1) In the above embodiment, the decoration member 70 is described as one example of the side surface member and the switch base 40 is described as one example of the upper surface member. However, any member may be used as the side surface member as long as it is configured as at least a portion of the vehicular interior side surface of the armrest 11. Any member may be used as the upper surface member as long as it is configured as at least a portion of the upper surface of the armrest 11.
(2) In the above embodiment, the vehicular door trim is described as one example of the vehicular interior component. Examples of the vehicular interior component may include any other vehicular interior component other than the door trim (such as an instrument panel, a pillar garnish, and roof lining), a vehicular interior component of an aircraft and a ship, and an interior component of a furniture such as a sofa and a chair.

1. A vehicular interior component comprising:
a projection portion projecting toward a vehicular interior side and configured as an armrest and including a wall portion that has a vehicular interior side surface;
an upper surface member mounted on the projection portion and configured as an upper surface of the armrest, the upper surface member including
an upper surface member body that covers the projection portion from above, and
a fitting portion that extends from the upper surface member body and has a through hole being through in an upper-bottom direction, the fitting portion including
a first extending portion that extends from the upper surface member body toward the vehicular interior side, and
a second extending portion that extends downward from a vehicular interior side end portion of the first extending portion and is contacted with the wall portion from the vehicular interior side; and
a side surface member mounted on the wall portion of the projection portion to cover the vehicular interior side surface of the projection portion and configured as a vehicular interior side surface of the armrest facing a vehicular interior space, the side surface member including
a side surface member body that covers the wall portion from the vehicular interior side and includes an upper portion that is on the vehicular interior side of the first extending portion and on an upper side of the first extending portion, and
a first stopper piece that extends from a vehicular exterior side surface of the upper portion to the through hole and is inserted in the through hole from above and is contacted with an inner surface of the through hole from the vehicular exterior side.

2. The vehicular interior component according to claim 1, wherein the upper surface member includes a second stopper piece that is fitted to the wall portion from the vehicular exterior side.

3. The vehicular interior component according to claim 1, wherein
the first stopper piece includes
an exterior extending portion that extends from the vehicular exterior side surface of the side surface member body toward the vehicular exterior side, and
a downward extending portion that extends downward from a vehicular exterior side end of the exterior extending portion and is inserted in the through hole from above and contacted with an inner surface of the through hole from the vehicular exterior side, and
the exterior extending portion covers a portion of a hole edge of the through hole that is a portion of the first extending portion from above.

4. The vehicular interior component according to claim 1, wherein the fitting portion has a tubular shape and includes the through hole therein.

5. The vehicular interior component according to claim 4, wherein
the fitting portion further includes an extending portion that has a plate shape and extends downward from the upper surface member body,
the first extending portion includes two first extending portions that have a plate shape and are opposite each other and extend from side edges of the extending portion toward the vehicular interior side,
the second extending portion extends to connect the two first extending portions and faces the extending portion, the second extending portion being on the vehicular interior side of the extending portion, and
the through hole is defined by the extending portion, the two first extending portions, and the second extending portion.

6. The vehicular interior component according to claim 2, wherein
the second stopper piece includes a fitting projection at a distal end thereof, and
the fitting projection is fitted in a fitting hole of the wall portion and contacted with a hole edge of the fitting hole from a lower side.

7. The vehicular interior component according to claim 3, wherein
the fitting portion further includes an extending portion that has a plate shape and extends downward from the upper surface member body,
the first extending portion includes two first extending portions that have a plate shape and are opposite each other and extend from side edges of the extending portion toward the vehicular interior side,
the second extending portion extends to connect the two first extending portions and faces the extending portion, the second extending portion being on the vehicular interior side of the extending portion, and
the through hole is defined by the extending portion, the two first extending portions, and the second extending portion.
